(19) United States
(12) Patent Application Publication
(10) Pub. No.: US 2010/0066630 A1
(43) Pub. Date: Mar. 18, 2010

(54) Dual-Band Antenna

(75) Inventors: Jia-Hung Su, Taipei Hsien (TW); Ching-Chi Lin, Taipei Hsien (TW); Kai Shih, Taipei Hsien (TW); Yu-Yuan Wu, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 12/209,597

(22) Filed: Sep. 12, 2008

(51) Int. Cl. H01Q 1/48

(52) U.S. Cl. 343/846

(57) ABSTRACT

A dual-band antenna has a grounding portion, two ends of which extend substantially perpendicular to the grounding portion towards a same side to form a first fixing portion and a second fixing portion. An antenna unit extends towards the first fixing portion from the second fixing portion. The antenna unit includes a basic portion spaced from the grounding portion, a feeding point positioned at the basic portion, and a first and second radiating portion extending towards the first fixing portion from the basic portion side by side to space from each other. The first radiating portion extends beyond the second radiating portion. A coupling portion extends towards the second fixing portion from the first fixing portion along a substantially longitudinal centerline of the second radiating portion, with a free end thereof away from the second radiating portion and beyond a free end of the first radiating portion to define a space therebetween.

### BACKGROUND OF THE INVENTION

1. Field of the Invention

The invention relates to a dual-band antenna, and particularly to a dual-band antenna applied in wireless local area network capable of covering many frequency bands and having good characteristics.

2. The Related Art

In recent years, portable electrical devices such as personal computers, mobile phones and PDAs incorporating wireless local area network (LAN) functions and standards such as IEEE802.11a/b have come into wide use. The IEEE802.11a covers the frequency band ranging between 5.1 GHz and 5.8 GHz, and the IEEE802.11b covers the frequency band ranging between 2.4 GHz and 2.5 GHz. Therefore, it is often desirable to realize or utilize all the frequency bands in accordance with the standards by one antenna. In order to achieve this, it is necessary to design an antenna capable of covering the frequency bands mentioned synchronously.

Currently, there are many kinds of dual-band antennas or multi-band antennas designed to be compatible with the IEEE802.11a and the IEEE802.11b. Thereinto, a planar inverted-F antenna (PIFA) is an embedded and miniaturized dual-band antenna which is widely used in mobile phone. However, the characteristics of the antenna are easy to be affected by many reasons, such as construction, size and ambience. Consequently, the characteristics of the PIFA, such as bandwidth, gain and efficiency, decrease, with the PIFA miniaturized in size and changed in construction.

### SUMMARY OF THE INVENTION

An object of the present invention is to provide a dual-band antenna applied in wireless local area network capable of covering many frequency bands and having good characteristics.

The dual-band antenna has a grounding portion, two ends of which extend substantially perpendicular to the grounding portion towards a same side to form a first fixing portion and a second fixing portion. An antenna unit extends towards the first fixing portion from the second fixing portion. The antenna unit includes a basic portion spaced from the grounding portion, a feeding point positioned at the basic portion, and a first and second radiating portion extending towards the first fixing portion from the basic portion side by side to space from each other. The first radiating portion extends beyond the second radiating portion. A coupling portion extends towards the second fixing portion from the first fixing portion along a substantially longitudinal centerline of the second radiating portion, with a free end thereof away from the second radiating portion and beyond a free end of the first radiating portion to define a space therebetween.

As described above, the first radiating portion and the second radiating portion are adapted for receiving the frequency bands ranging between 2.4 GHz and 2.5 GHz, and 4.9 GHz and 5.2 GHz, respectively. The coupling portion extends beyond the free end of the first radiating portion so as to generate the coupling effect therebetween, which makes the dual-band antenna capable of receiving the electromagnetic signal ranging between 4.9 GHz and 5.8 GHz. Meanwhile, the coupling portion, as a radiating portion, can obtain an electrical resonance which is superimposed on an electrical resonance generated by the second radiating portion to enlarge the receiving bandwidth and increase the efficiency thereof. Therefore, the dual-band antenna is capable of covering many frequency bands, meanwhile, has the good characteristics.

### BRIEF DESCRIPTION OF THE DRAWINGS

The present invention will be apparent to those skilled in the art by reading the following description of an embodiment thereof, with reference to the attached drawings, in which:

FIG. 1 is a perspective view illustrating the structure of a dual-band antenna according to an embodiment of the present invention;

FIG. 2 is a Smith chart recording impedance of the dual-band antenna shown in FIG. 1; and

FIG. 3 shows a Voltage Standing Wave Ratio (VSWR) test chart of the dual-band antenna shown in FIG. 1.

### DETAILED DESCRIPTION OF THE PREFERRED EMBODIMENT

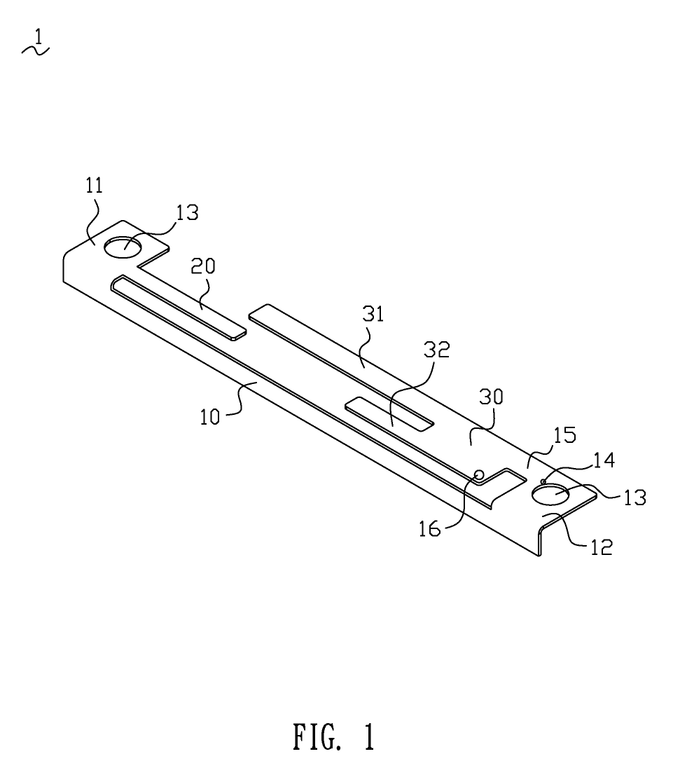

Please refer to FIG. 1, an embodiment of a dual-band antenna 1 according to the present invention is shown. The dual-band antenna 1 has a grounding portion 10. The grounding portion 10 is an elongated shape. Two ends of the grounding portion 10 extend substantially perpendicular to the grounding portion 10 toward a same side to form a first fixing portion 11 and a second fixing portion 12 away from the first fixing portion 11. The first and second fixing portion 11 and 12 are rectangular and disposed on an insulating housing (not shown). In this embodiment, the first fixing portion 11 and the second fixing portion 12 respectively have a positioning hole 13 for positioning the dual-band antenna 1. A grounding point 14 is disposed at the second fixing portion 12 and near the positioning hole 13.

A side of the first fixing portion 11 facing the second fixing portion 12 connects with a coupling portion 20. In this embodiment, the coupling portion 20 extends towards the second fixing portion 12 from the side of the first fixing portion 11. The coupling portion 20 is an elongated shape. A side of the second fixing portion 12 facing the first fixing portion 11 extends towards the first fixing portion 11 to form a connecting portion 15. The connecting portion 15 is a short-strip shape and disposed away from the grounding portion 10. A free end of the connecting portion 15 connects with an antenna unit. The antenna unit includes a basic portion 30, a first radiating portion 31 and a second radiating portion 32. The basic portion 30 is of flat-board shape and spaced from the grounding portion 10. In this embodiment, the basic portion 30 extends from the free end of the connecting portion 15 towards the first fixing portion 11 and the grounding portion 10 to show a rectangular shape. A feeding point 16 is disposed at a corner of the basic portion 30 adjacent to the grounding portion 10 and the second fixing portion 12.

The first and second radiating portion 31 and 32 extend towards the first fixing portion 11 from a side of the basic portion 30 facing the first fixing portion 11 and are all elongated shape. The first radiating portion 31 is arranged side by side and spaced from the second radiating portion 32. The first radiating portion 31 is farther to the grounding portion 10 than the second radiating portion 32, and the first radiating portion 31 is longer than the second radiating portion 32 with a free end located beside the coupling portion 20 to form a space therebetween. The second radiating portion 32 extends substantially along the longitudinal centerline of the coupling portion 20, with a free end thereof spaced from the coupling portion 20 with a long distance.

When the dual-band antenna 1 operates at wireless communication, a current is fed from the feeding point 16 to the first radiating portion 31 to generate an electrical resonance of a frequency band ranging between 2.4 GHz and 2.5 GHz. While the current is fed from the feeding point 16 to the second radiating portion 32 to generate an electrical resonance of a frequency band ranging between 4.9 GHz and-5.2 GHz. The coupling portion 20 extends beyond the free end of the first radiating portion 31 so as to generate coupling effect therebetween, which makes the dual-band antenna 1 capable of receiving an electromagnetic signal from a frequency band ranging from 4.9 GHz to 5.8 GHz. The coupling portion 20 also can obtain an electrical resonance which is superimposed upon an electrical resonance generated by the second radiating portion 32, which can enlarge the receiving frequency band of the dual-band antenna 1 and improve the gain of the dual-band antenna 1.

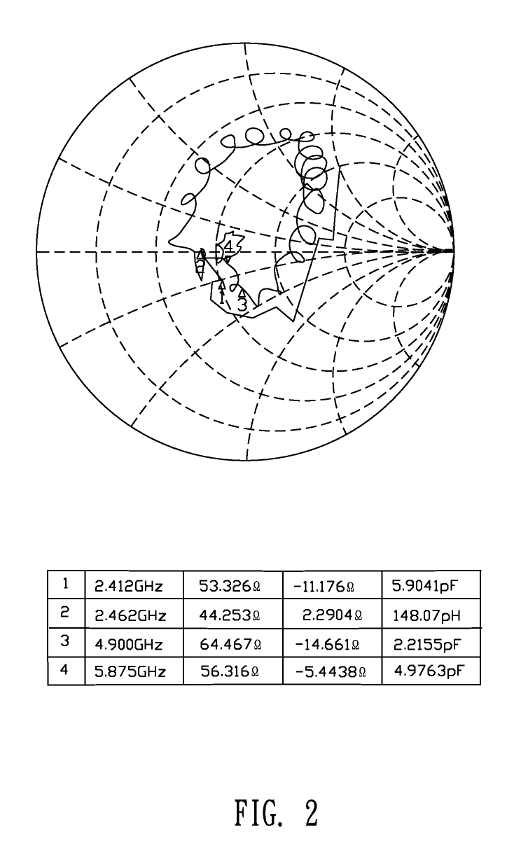

Please refer to FIG. 2, which shows a Smith chart recording impedance of the dual-band antenna 1 in the embodiment when the dual-band antenna 1 operates at wireless communication. The dual-band antenna 1 exhibits an impedance of (53.326−j11.176) Ohm at 2.412 GHz, an impedance of (44.253+j2.2904) Ohm at 2.462 GHz, an impedance of (64.467−j14.661) Ohm at 4.9 GHz and an impedance of (56.316−j5.4438) at 5.875 GHz. Therefore, the dual-band antenna 1 has good impedance characteristics.

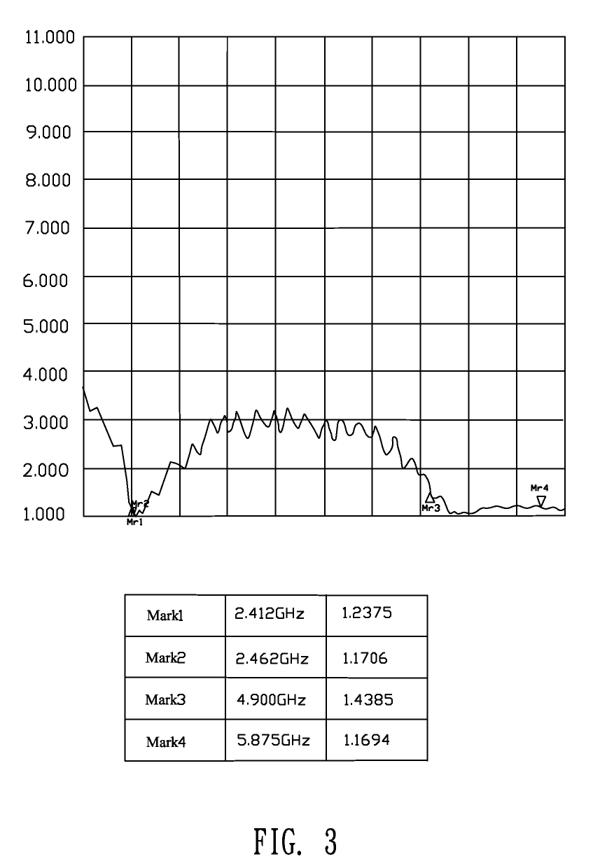

Please refer to FIG. 3, which shows a Voltage Standing Wave Ratio (VSWR) test chart of the dual-band antenna 1 in the embodiment when the dual-band antenna 1 operates at wireless communication. When the dual-band antenna 1 operates at 2.412 GHz (indicator Mr1 in FIG. 3), the VSWR value is 1.2375. When the dual-band antenna 1 operates at 2.462 GHz (indicator Mr2 in FIG. 3), the VSWR value is 1.1706. When the dual-band antenna 1 operates at 4.9 GHz (indicator Mr3 in FIG. 3), the VSWR value is 1.4385. When the dual-band antenna 1 operates at 5.875 GHz (indicator Mkr4 in FIG. 3), the VSWR value is 1.1694. The VSWR value of the dual-band antenna 1 is below 2. This means that the dual-band antenna 1 has preferable frequency response between 2.4 GHz and 2.5 GHz, and 4.9 GHz and 5.8 GHz.

As described above, the first radiating portion 31 and the second radiating portion 32 are adapted for receiving the frequency bands ranging between 2.4 GHz and 2.5 GHz, and 4.9 GHz and 5.2 GHz, respectively. The coupling portion 20 extends beyond the free end of the first radiating portion 31 so as to generate the coupling effect therebetween, which makes the dual-band antenna 1 capable of receiving the electromagnetic signal ranging between 4.9 G and 5.8 G Meanwhile, the coupling portion 20, as a radiating portion, can obtain an electrical resonance which is superimposed on an electrical resonance generated by the second radiating portion 32 to enlarge the receiving bandwidth and increase the efficiency thereof. Therefore, the dual-band antenna 1 is capable of covering many frequency bands and has good characteristics.

Furthermore, the present invention is not limited to the embodiments described above; various additions, alterations and the like may be made within the scope of the present invention by a person skilled in the art. For example, respective embodiments may be appropriately combined.

What is claimed is:

1. A dual-band antenna, comprising:
a grounding portion of elongated shape, two ends of the grounding portion extending substantially perpendicular to the grounding portion towards a same side to form a first fixing portion and a second fixing portion away from each other;
an antenna unit extending towards the first fixing portion from a side of the second fixing portion facing the first fixing portion, the antenna unit including a basic portion of plate-shape spaced from the grounding portion, a feeding point positioned at the basic portion, and a first and second radiating portions of elongated shape extending towards the first fixing portion from the basic portion side by side to space from each other, the first radiating portion extending beyond the second radiating portion; and
a coupling portion of elongated shape extending towards the second fixing portion from a side of the first fixing portion facing the second fixing portion along a substantially longitudinal centerline of the second radiating portion, a free end of the coupling portion away from the second radiating portion and beyond a free end of the first radiating portion to define a space therebetween.

2. The dual-band antenna as claimed in claim 1, further comprising a connecting portion connecting portions of the basic portion and the second fixing portion far away from the grounding portion.

3. The dual-band antenna as claimed in claim 1, wherein the second radiating portion is nearer to the grounding portion than the first radiating portion.

4. The dual-band antenna as claimed in claim 1, wherein the first fixing portion and the second fixing portion respectively have a positioning hole for positioning the dual-band antenna.

5. The dual-band antenna as claimed in claim 4, wherein the second fixing portion defines a grounding point near the positioning hole.

6. The dual-band antenna as claimed in claim 1, wherein the feeding point is positioned at a corner of the basic portion near the grounding portion and the second fixing portion.
